(19) United States
(12) Patent Application Publication
(10) Pub. No.: US 2016/0312377 A1
(43) Pub. Date: Oct. 27, 2016

(54) Laser Deposit Surface Control Using Select Fluxes and Electrochemistry

(71) Applicant: Siemens Energy, Inc., Orlando, FL (US)

(72) Inventors: Gerald J. Bruck, Oviedo, FL (US); Ahmed Kamel, Orlando, FL (US)

(21) Appl. No.: 14/691,610

(22) Filed: Apr. 21, 2015

(51) Int. Cl. C25F 3/16; B23K 25/00; B23K 26/34

(52) U.S. Cl. CPC C25F 3/16; B23K 26/34; B23K 25/005

(57) ABSTRACT

Method and apparatus (20) for forming a smooth metal surface (42) on a metal substrate (22). A melt pool (32) solidifying under a layer of molten electrolytic slag (34) on the metal substrate is subjected to a DC current (12) between a cathode (28) in contact with the molten slag and the substrate, thereby causing anodic leveling of the surface. The cathode may be buried in a layer of flux material (26) which is melted by a laser beam (30) traversing the substrate. A filler material (24) may be melted coincidently in an additive process. The flux material includes electrolytic, optically transmissive and viscosity reducing constituents.

### FIELD OF THE INVENTION

This invention relates to apparatus and methods for laser fabrication and repair of metal components, and particularly relates to electrochemical smoothing of a solidified melt pool through electrolytic liquid slag thereon.

### BACKGROUND OF THE INVENTION

It is often desired to produce a smooth surface on a metal article to control geometry or to improve performance or appearance. Metal deposition processes utilizing a flux material, such as submerged arc welding or flux core arc welding, sometimes produce a pock marked surface due to the accumulation of gas such as carbon monoxide at the interface between the molten metal and slag resulting from melting of flux and reaction with carbon. The present inventors have developed processes for depositing superalloy materials using a laser heat source to melt powdered superalloy material and flux. See, for example, United States patent application publication number US 2013/0136868 A1. It is expected that some applications of such flux assisted laser deposition processes may be susceptible to pock marking or may otherwise require post-deposition processing to achieve a desired surface finish.

Electropolishing is an electrochemical process that deburrs and smoothes a surface of a metal article, and it is one post-deposition process that may be used to smooth the surface of a laser-deposited material. The surface is immersed in an electrolyte and is connected to positive direct current, making it an anode. Current flows from the surface to a cathode through the electrolyte via metal ions removed from the surface. Burrs and other projections become areas of high current density and are preferentially eroded, resulting in a process called anodic leveling. This is effective on many surface shapes including complex, high resolution surfaces that are not amenable to mechanical smoothing. Electropolishing and other surface smoothing processes add time and expense to any material deposition processes, and thus, further improvements are desired.

### BRIEF DESCRIPTION OF THE DRAWINGS

The invention is explained in the following description in view of the drawings that show:

FIG. 1 is a schematic front sectional view of an apparatus according to aspects of the invention.

FIG. 2 is an enlarged schematic front sectional view of an apparatus according to further aspects of the invention.

### DETAILED DESCRIPTION OF THE INVENTION

The present inventors have devised a technique for electropolishing newly solidified metal formed during laser material deposition repair or fabrication by using molten flux/slag on the deposit as the electrolyte. The combined flux-assisted laser deposition/electropolishing process may produce a smoother surface at a lower cost on a shorter schedule than prior art sequential deposition/smoothing processes.

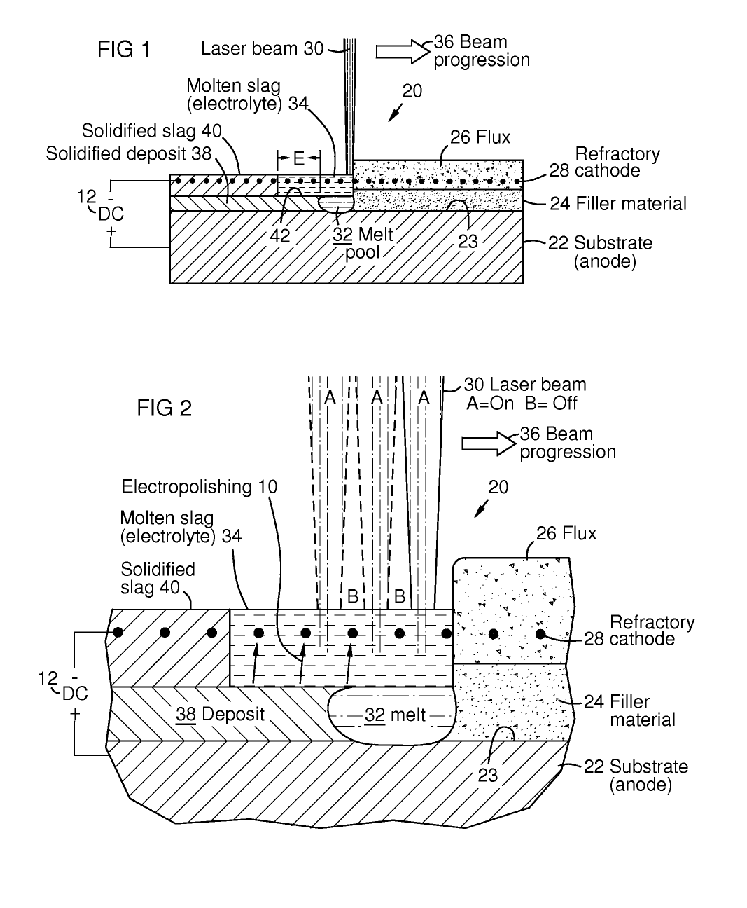

FIG. 1 is a schematic sectional view of an apparatus 20 operating on a substrate 22 according to aspects of the invention. A layer 24 of a filler material may be placed on a surface 23 of the substrate. A flux layer 26 is placed on the filler layer 24 or directly onto the substrate for a non-additive repair. A refractory cathode 28 is placed in contact with the flux. The cathode is an electrical conductor with a higher melting point than the laser processing temperature that reaches the cathode—for example, higher than the melting point of the filler material 24. Exemplary cathode materials include niobium, molybdenum, tantalum, tungsten, and rhenium. The cathode may be formed as a plurality of wires in the flux. Spaces between the wires allow laser heat penetration to the filler material 24 or substrate. For example, the wires may be parallel or may form a screen with interstitial spaces. The cathode 28 and substrate (anode) 22 are connected to a DC power source 12 as illustrated. A laser beam 30 is directed onto the flux 26, creating a melt pool 32 of filler material and/or substrate metal covered by melted flux material which forms a molten slag 34. The laser beam 30 progresses in relative direction 36 over the flux 26, leaving the melt pool and molten slag to solidify into a solidified deposit 38 and solidified slag 40. The melt pool may have a higher solidification temperature than the molten slag, so the melt pool 32 solidifies first, leaving a zone E where the solidified deposit 38 is covered by molten slag 34. Alternatively, the melt pool 32 may solidify first regardless of its solidification temperature relative to that of the molten slag due to heat transfer into the substrate 22. Under the influence of the DC power source 12, the region E of molten slag 34 above solidified deposit 38 enables a period of electropolishing (anodic leveling) 10 of the solidified surface 42 of the deposited filler material (or substrate material for non-additive embodiments) until the slag solidifies.

The present inventors have disclosed flux compositions that are useful for the laser deposition of superalloy material. See United States patent application publication US 2015/0027993 A1, incorporated by reference herein. The flux 26 of the present invention contains electrolytic constituents that are liquid at the laser processing temperatures of the filler material. For example, the flux may form liquid slag in a temperature range above 1300° C. at an atmospheric pressure of 1013 millibars. An embodiment of flux may include one or more of the following:

a) 40-80 wt % CaF₂

b) 5-40 wt % Al₂O₃

c) 1-15 wt % SiO₂

d) >0-20 wt % MnO

e) >0-15 wt % CaO

f) >0-7 wt % MgO

g) >0-7 wt % TiO₂

h) >0-10 wt % Fe₂O₃ and/or Fe₃O₄

In another embodiment, a filler layer 24 is not provided. The melt pool 32 is formed by melting the surface 23 of the substrate 22 for crack repair and surface restoration. Alloy constituents that have been depleted near the surface of the substrate, such as aluminum, may be restored by constituent additions in the flux 26 as pure elements, metal compounds, or alloys and in various forms including powder and foil.

FIG. 2 schematically illustrates the laser beam 30 being turned on A and off B as it passes respectively between or over the wires of the refractory cathode 28. The spaces between the wires of the cathode allow the laser beam to penetrate through the flux to the filler metal 24 or the substrate 22 without direct impingement onto the wires of the cathode 28, which by way of applied electrical current 12 accomplish electropolishing 10.

It is advantageous to make the flux optically transparent or translucent to laser light, as described by the present inventors in United States patent application publication US 2014/0220374 A1, which is also incorporated by reference herein. This can be done by constituting the flux of optically transmissive constituents in a range of 5-60 wt % or 20-40% wt %, as examples. Optically transmissive constituents include metal oxides, metal salts, metal silicates, and various fluorides. Examples include alumina (Al₂O₃); silica (SiO₂); zirconium oxide (ZrO₂); sodium silicate (Na₂SiO₃); potassium silicate (K₂SiO₃); zinc selenide (ZnSe); magnesium, calcium, and barium fluorides (MgF₂, CaF₂, BaF₂); and other compounds capable of optically transmitting laser energy, for example as generated from Nd:YAG and Yb fiber lasers. Some optically transmissive constituents are also electrolytic constituents. The following list provides exemplary ranges of constituents for a flux that is both optically transmissive and electrolytic:

a) 40-80 wt % CaF₂

b) 5-40 wt % Al₂O₃

c) 1-15 wt % SiO₂

It is also advantageous that the molten slag have low viscosity to facilitate leveling of the surface 23 of the deposit by surface tension and/or by facilitating the release of gasses from the interface of the molten metal and flux. Viscosity may be reduced by including in the flux one or more viscosity reducing constituents totaling a greater proportion than any viscosity increasing constituents such as Al₂O3₃, TiO₂F, and SiO₂. Viscosity increasing constituents (VIC herein) form a network of covalent bonds, while viscosity reducing constituents (VRC herein) interfere with such network formation. Such properties of materials can be found in available handbooks and online resources such as provided by the ASM International professional society.

Examples of viscosity reducing constituents include one or more of CaO, MnO, Fe₂O₃, CaF₂, Na₃AlF₆, MgO, Na₂O (maximum 5 wt %), and K₂O (maximum 5 wt %). Some exemplary ranges of low viscosity, optically transmissive, electrolytic fluxes are shown in the following table. In general, the flux may contain one or more electrolytic constituents; one or more optically transmissive constituents (OTC), including any electrolytic constituents that are also optically transmissive; and one or more viscosity reducing constituents (VRC) totaling a greater weight % than any viscosity increasing constituents (VIC).

TABLE 1

| | Electro- | | Viscosity |
|---|---|---|---|
| Embodi- | lytic | Optically | Reducing |
| ment | weight % | Transmissive (OTC) | (VRC) |
| A | 40-80% CaF₂ | Included in the electrolytic, | VRC > VIC |
| | | but also may include other | |
| | | OTCs e.g. MgF₂ and BaF₂. | |
| B | 5-40% Al₂O₃ | Included in | VRC > VIC |
| | | the electrolytic | |
| C | 1-15% SiO₂ | Included in | VRC > VIC |
| | | the electrolytic | |

For example, in one embodiment the flux may comprise 1-15 weight % of SiO₂ as an optically transmissive and electrolytic component; and at least one further electrolytic component selected from the group of CaO and MgO; and a viscosity reducing proportion of one or more components including CaF₂ having a total weight % greater than a total weight % of any and all viscosity increasing components in the flux

Upon cooling of the apparatus 20 following laser processing, the slag is removed to reveal the smooth surface 42. The cathode 28 is encased in the solidified slag 40 and it may facilitate slag removal from the substrate 22. The cathode 28 may be reused by mechanically breaking the brittle slag off of the cathode 28.

The invention overcomes the following obstacles:

a) Electrolytes used for prior art electropolishing vaporize at the laser processing temperatures of molten metal. Exemplary conventional electrolytes include mixtures of sulfuric acid and phosphoric acid, perchlorates with acetic anhydride, and methanolic solutions of sulfuric acid.

b) Conventional cathode materials such as lead, copper, and stainless steel, would melt at the laser processing temperatures of high-temperature superalloys.

c) A cathode in the flux or molten slag could block the laser beam used to melt the filler or substrate and may be damaged by the beam.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. An arrangement comprising:
a laser beam that creates a metal melt pool as it traverses across a metal substrate;
a flux that forms an electrolytic liquid slag on the melt pool at a liquid temperature of the melt pool and remains liquid on a solidified metal formed by solidification of the melt pool as the laser beam traverses; and
an electrical circuit comprising a cathode in contact with the liquid slag and a connection to the substrate that makes the solidified metal an anode;
wherein anodic leveling of a surface of the solidified metal is enabled during a period when the liquid slag remains liquid thereon.

2. The arrangement of claim 1, wherein the flux comprises at least one of the group of:
a) 40-80 wt % CaF₂
b) 5-40 wt % Al₂O₃
c) 1-15 wt % SiO₂
d) >0-20 wt % MnO
e) >0-15 wt % CaO
f) >0-7 wt % MgO
g) >0-7 wt % TiO₂
h) >0-10 wt % Fe₂O₃ and/or Fe₃O₄

3. The arrangement of claim 1, wherein the flux comprises:
1-15 weight % of SiO₂ as an optically transmissive and electrolytic component;
at least one electrolytic component selected from the group of CaO and MgO; and
a proportion of one or more viscosity reducing components including CaF₂, said proportion having a total weight % greater than a total weight % of any and all viscosity increasing components in the flux.

4. The arrangement of claim 1, wherein the cathode comprises a plurality of wires with spaces there between for penetration of the laser beam through the flux.

5. The arrangement of claim 1, wherein the cathode comprises a screen in the flux with interstitial spaces therein for penetration of the laser beam there through.

6. The arrangement of claim 1, wherein the cathode comprises at least one of niobium, molybdenum, tantalum, tungsten, and rhenium.

7. The arrangement of claim 1, wherein the flux comprises: one or more electrolytic constituents; one or more optically transmissive constituents; and one or more viscosity reducing constituents; and wherein the viscosity reducing constituents total a greater weight % than a total weight % of any viscosity increasing constituents in the flux.

8. The arrangement of claim 7, wherein said any viscosity increasing constituents comprises one or more of Al₂O3₃, TiO₂, and SiO₂.

9. The arrangement of claim 7, wherein the one or more viscosity reducing constituents are selected from CaO, MnO, Fe₂O₃, CaF₂, Na₃AlF₆, MgO, Na₂O, and K₂O.

10. The arrangement of claim 1, wherein the flux comprises one of the following embodiments:

| | Electro- | | Viscosity |
|---|---|---|---|
| Embodi- | lytic | Optically | Reducing |
| ment | weight % | Transmissive (OTC) | (VRC) |
| A | 40-80% CaF₂ | Included in the electrolytic, | VRC > VIC |
| | | but also may include other | |
| | | OTCs e.g. MgF₂ and BaF₂. | |
| B | 5-40% Al₂O₃ | Included in | VRC > VIC |
| | | the electrolytic | |
| C | 1-15% SiO₂ | Included in | VRC > VIC |
| | | the electrolytic | |

11. The arrangement of claim 1, wherein the melt pool comprises a filler material.

12. A method comprising:
forming a melt pool covered by a molten electrolytic slag on a metal substrate; and
establishing a direct current between a cathode in contact with the molten slag and the substrate as an anode while the melt pool solidifies under the molten slag to form a solidified surface, thereby effecting anodic leveling of the solidified surface.

13. The method of claim 12, further comprising:
allowing the molten slag to solidify to encase the cathode;
removing the solidified slag and cathode to reveal the solidified surface; and
removing the solidified slag from the cathode to prepare it for reuse.

14. The method of claim 12, further comprising:
forming the cathode as a plurality of wires; and
traversing a laser beam across the substrate to form the melt pool while avoiding direct impingement of the beam onto the wires as it is traversed across the substrate.

15. The method of claim 12, further comprising:
melting a flux onto the metal substrate to form the molten electrolytic slag; and
selecting a composition of the flux to comprise one or more viscosity reducing constituents comprising a total weight greater than a total weight of any viscosity increasing components in the flux.

16. The method of claim 12, further comprising:
depositing flux onto the metal substrate to be melted to form the molten electrolytic slag; and
selecting a composition of the flux to comprise 40-80 weight % of CaF₂ as an optically transmissive and electrolytic component, and to comprise a proportion of one or more viscosity reducing components including the CaF₂, said proportion having a total weight % greater than a total weight % of any and all viscosity increasing components in the flux.

17. The method of claim 12, further comprising:
depositing flux onto the metal substrate to be melted to form the molten electrolytic slag; and
selecting a composition of the flux to comprise 5-40 weight % of Al₂O₃ as an optically transmissive and electrolytic component, and to comprise a proportion of one or more viscosity reducing components, said proportion having a total weight % greater than a total weight % of any and all viscosity increasing components in the flux.

18. The method of claim 12, further comprising:
depositing flux onto the metal substrate to be melted to form the molten electrolytic slag; and
selecting a composition of the flux to comprise 1-15 weight % of SiO₂ as an optically transmissive and electrolytic component; to further comprise at least one electrolytic component selected from the group of CaO and MgO; and to comprise a proportion of one or more viscosity reducing components including CaF₂, said proportion having a total weight % greater than a total weight % of any and all viscosity increasing components in the flux.

19. The method of claim 12, further comprising selecting the cathode to comprise at least one of niobium, molybdenum, tantalum, tungsten, and rhenium.

20. A flux composition for laser processing of a metal substrate, the flux composition comprising at least one electrolytic constituent; at least one optically transmissive constituent; and at least one viscosity reducing constituent; wherein said at least one viscosity reducing constituent comprises a total weight % greater than a total weight % of any and all viscosity increasing constituents in the flux.
